(19) United States
(12) Patent Application Publication
(10) Pub. No.: US 2007/0027980 A1
(43) Pub. Date: Feb. 1, 2007

(54) Offline management of wireless devices

(76) Inventors: Allan Herrod, Mission Viejo, CA (US); James A. Buccigrossi, West Mifflin, PA (US); Vikranth Katpally-Reddy, Foster City, CA (US)

Correspondence Address: FAY KAPLUN & MARCIN, LLP, 15O BROADWAY, SUITE 702, NEW YORK, NY, 10038, US

(21) Appl. No.: 11/191,297

(22) Filed: Jul. 28, 2005

(51) Int. Cl. G06F 15/173

(52) U.S. Cl. 709/224

(57) ABSTRACT

Described is a method including receiving an offline management policy from an enterprise management system of a network, the offline management policy including a triggering parameter and a management action and storing the offline management policy. The collected parameter is compared to the triggering parameter when a device is offline from the network and the management action is initiated when the collected parameter satisfies the triggering parameter.

### BACKGROUND INFORMATION

Wireless networks are deployed in a great number of industries such as retail environments, transportation and logistics, manufacturing, warehousing, etc. These wireless networks may include large numbers of mobile units, wireless switches and access points. The mobile devices may be managed as part of an overall enterprise management system. However, this management depends on the mobile device being connected to the wireless network. It may also be important to manage the mobile devices when they are offline (e.g., out of contact with the wireless network).

### SUMMARY OF THE INVENTION

A method including receiving an offline management policy from an enterprise management system of a network, the offline management policy including a triggering parameter and a management action, storing the offline management policy, comparing, when a device is offline from the network, a collected parameter to the triggering parameter and initiating the management action when the collected parameter satisfies the triggering parameter.

A device having a protocol application for wirelessly connecting to a network and a plurality of software applications. The device also includes a wireless agent to receive an offline management policy from an enterprise management system of the network, the offline management policy including a triggering parameter and a management action, compare, when the device is in an offline mode, a collected parameter to the triggering parameter and initiate the management action when the collected parameter satisfies the triggering parameter.

A system including an enterprise management system residing on a network device for managing a wireless network, the enterprise management system including an offline management policy. The system further includes a wireless agent residing on a second network device, the enterprise management system sending the offline management policy to the wireless agent when the second network device is connected to the network, wherein the wireless agent manages the second network device using the offline management policy when the second network device is not connected to the wireless network.

### BRIEF DESCRIPTION OF THE DRAWINGS

FIG. 1 shows an exemplary network including a wireless network which may implement an exemplary embodiment according to the present invention.

FIG. 2 shows an exemplary mobile unit including exemplary software components.

FIG. 3 shows an exemplary communication path between network devices according to the present invention.

FIG. 4 shows an exemplary embodiment of a method of offline management of a wireless device according to the present invention.

### DETAILED DESCRIPTION

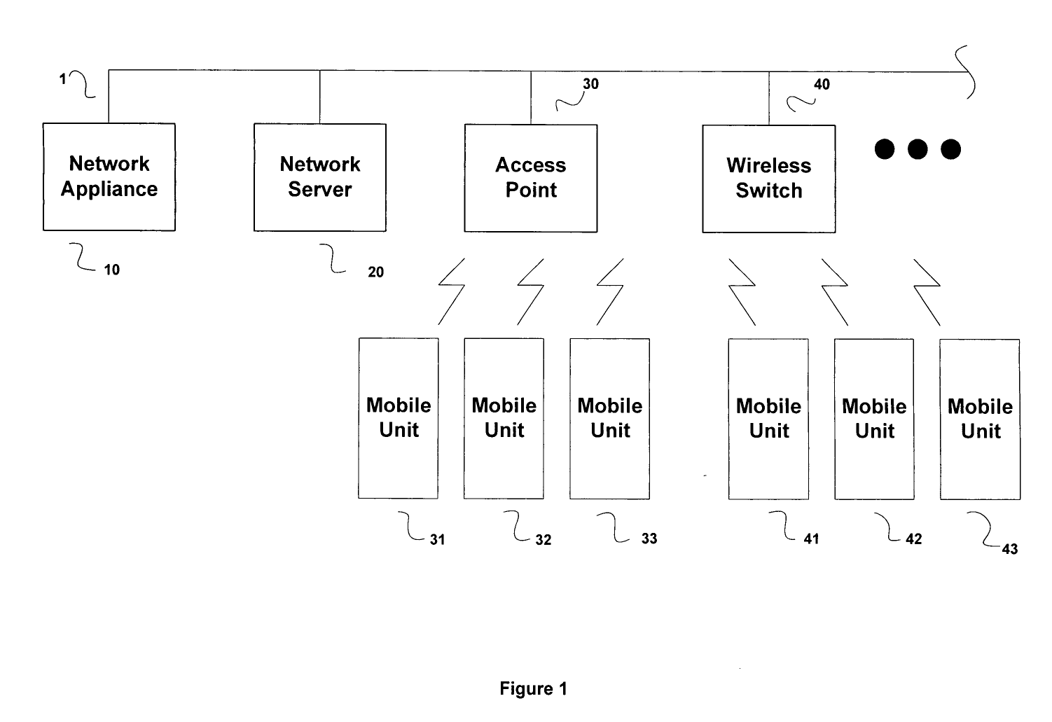

The present invention may be further understood with reference to the following description and the appended drawings, wherein like elements are provided with the same reference numerals. FIG. 1 shows an exemplary network 1 including a wireless network which may implement an exemplary embodiment of the present invention. The network 1 includes a network appliance 10, a network server 20, an access point 30 and a wireless switch 40. Each of these devices are shown as interconnected via a wired portion of the network 1. However, those of skill in the art will understand that these devices may also be wirelessly connected to the network 1. In addition, network 1 may also include any number of additional network components and/or devices (not shown).

FIG. 1 also shows mobile units 31-33 wirelessly connected to the network 1 via the access point 30. The mobile units 31-33 may be any type of computing or processor based device such as desktop or laptop computers, personal digital assistants, mobile phones, pagers, scanners, etc. The mobile units 31-33 and access point 30 may operate within any type of wireless networking environment, e.g., Wireless Local Area Network (“WLAN”), Wireless Wide Area Network (“WWAN”), etc. Communication between the mobile units 31-33 and the access point 30 may be accomplished using any wireless protocol such as IEEE 802.11, Bluetooth, etc. Similarly, mobile units 41-43 are wirelessly connected to the network 1 via the wireless switch 40. Those of skill in the art will understand that the network 1 is only exemplary and that the exemplary embodiment of the present invention may be implemented on any network which includes a wireless portion.

The owner of the above described exemplary network or any other network including wireless devices faces a variety of issues in operating and maintaining the network in its optimum state. Thus, the owner may implement an enterprise management system to manage some or all of the devices on the network 1. The enterprise management system may be a centralized management system for managing individual devices connected to the wireless network. The system may provide a series of services which allow a system administrator to both monitor and control the network 1 and the individual devices on the network.

Typically, the enterprise management system will reside on a network device such as the network appliance 10. However, those of skill in the art will understand that the system may reside on any of a variety of devices in the network 1, e.g., network server 20.

The devices which are connected by wire (e.g., the network server 20, the access point 30, the wireless switch 40) to the network management system (e.g., residing on network appliance 10) are generally continuously connected to the network 1. That is, the devices, when operating properly, are online and the network management system is in continuous contact with the devices for the purposes of managing the devices.

However, the mobile units 31-33 and 41-43 may operate online (in contact with network 1) or offline (out of contact with network 1). However, for the mobile units 31-33 and 41-43, offline operation does not indicate that the device is operating improperly. In fact, offline operation of mobile units is common for wireless networks because it is often required that the mobile units move into locations not covered by their network communications device (e.g., access point 30 and wireless switch 40). There may also be other reasons for offline operation of mobile units.

During these periods of offline operation, the mobile units 31-33 and 41-43 are not in contact with the network 1 and consequently, not in contact with the network management system. Thus, the network management system does not have real time management control over these offline devices. This does not mean that these offline device do not need to be managed, but merely that the network management system does not have access to these offline devices in order to affect management. Thus, the exemplary embodiments of the present invention allows for command and control of offline devices.

It should be noted that the exemplary embodiment of the present invention are described with reference to offline operation of mobile units. However, the present invention may be implemented for any network device which may operate offline.

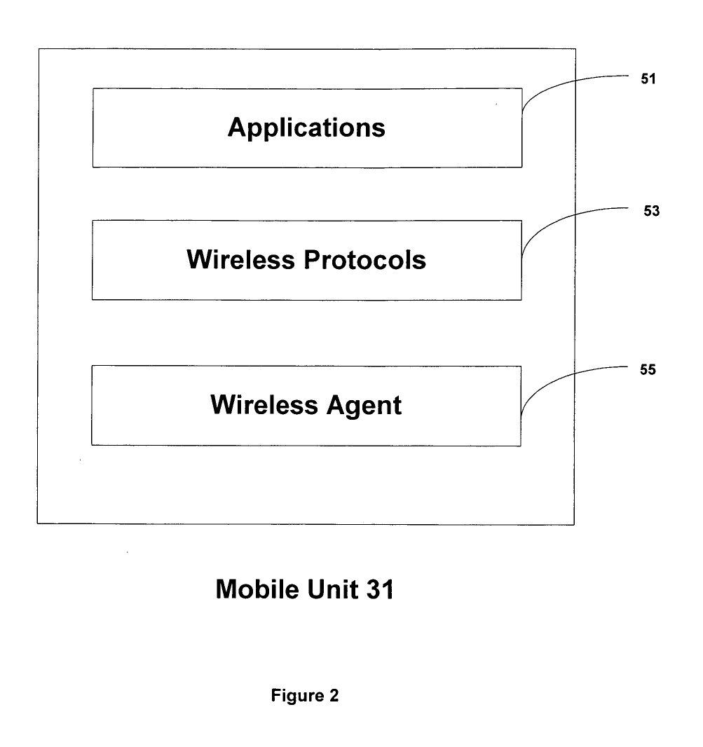

FIG. 2 shows an exemplary mobile unit 31 from the network 1 described with reference to FIG. 1. The mobile unit 31 includes various software components including applications 51, wireless protocols 53 and a wireless agent 55. Other software components may also be included in the mobile unit 31, e.g., an operating system. The applications 51 are those software components which allow the mobile unit 31 to perform the desired functionality. The wireless protocols 53 are the software components which allow the mobile unit 31 to communicate with the access point 30 or other mobile units.

The wireless agent 55 is a software component that includes functionality for management of the wireless device by a network management system such as described above. The wireless agent 55 resides on each of the mobile units in the network 1 (e.g., mobile units 31-33 and 41-43) and collects information on the mobile unit. The wireless agent 55 may collect information or attributes such as battery level, available memory, receiving/transmission bandwidth, etc. There are any number of examples of attributes which may be collected by the wireless agent 55 including, but not limited to, scanning attributes (e.g., number of good decodes, number of bad decodes, most recent scan, most recent scan length, etc.), wireless signal attributes (e.g., signal quality, signal strength, etc.), wireless throughput attributes (e.g., average link speed, bytes sent, bytes received, current link speed, etc.), user authentication attributes (e.g., login count, login failures, etc.), etc. Those of skill in the art will understand that the above attributes are only exemplary and that there may be hundreds or even thousands of attributes which may be collected for any given device. Each of the mobile units 31-33 and 41-43 of the network 1 will include a separate wireless agent 55 to collect such information on the individual mobile unit.

Thus, the wireless agent 55 may receive inputs from a variety of sources within the mobile unit 31 in order to collect this information on the mobile unit 31. For example, the operating system of the mobile unit 31 may monitor the battery level. The wireless agent 55 may query the operating system or receive an input from the operating system to determine the current state of the battery life. In a further example, the wireless agent 55 may query or receive an input from the wireless protocols 53 which indicates the current transmission bandwidth of the mobile unit 31.

Those of skill in the art will understand that the wireless agent 55 is shown as a separate software component in the example of FIG. 2. However, it is possible that the functionality described for the wireless agent is bundled with other software components that are loaded onto the mobile device or is a plug-in to other software components, e.g., the operating system, the wireless protocols, etc.

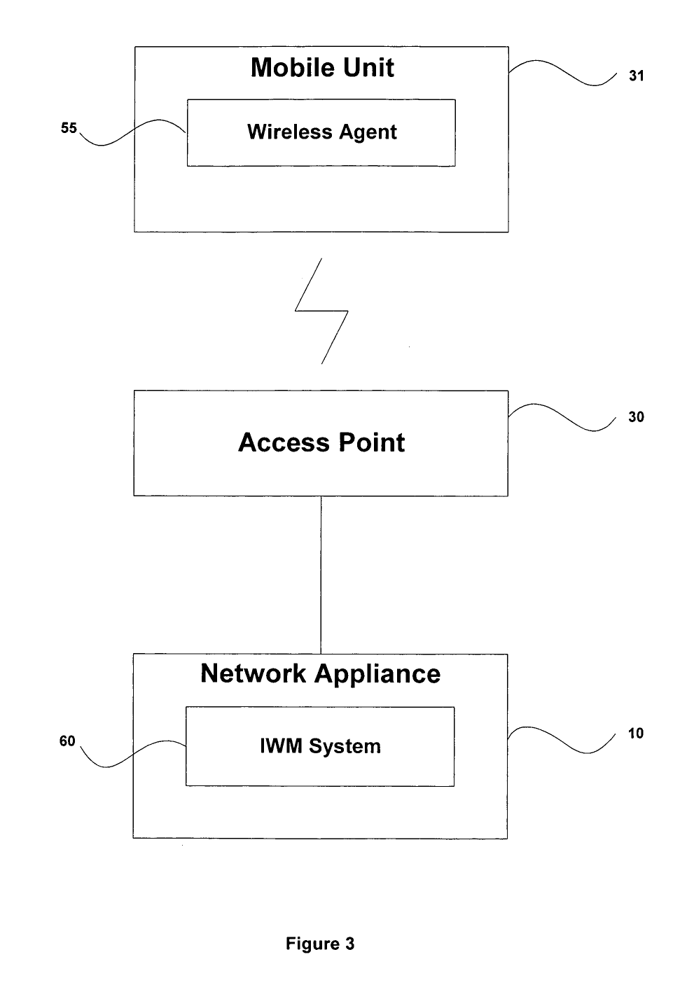

FIG. 3 shows an exemplary communication path between network devices. In this example the communication path is between the mobile unit 31 the access point 30 and the network appliance 10. The communication path operates bi-directionally, i.e., the network appliance 10 may send messages to the mobile unit 31 and vice versa. The network appliance 10 is shown as including an Integrated Wireless Management (“IWM”) system 60 (e.g., a network management system). This is the system which may be used to manage the wireless network. An example of an IWM system is provided in U.S. patent application Ser. No. 10/891,619 filed on Jul. 15, 2004 and entitled “Service Oriented Platform Architecture for a Wireless Network.” However, the present invention may be implemented without regard to the specific type of network management system.

In the online situation, the information that is collected by the wireless agent 55 is communicated to the IWM system 60 on the network appliance 10. The IWM system 60 may then manage the mobile device 31 and/or the network 1 using the information provided by the wireless agent 55. The IWM system 60 manages the mobile device 31 and/or the network 1 based on a set of management policies that are provided within the IWM system 60 allowing a network administrator to maintain control of the entire network 1.

In the online situation, when the information collected by the wireless agent 55 is transmitted to the IWM system 60 and this causes a “firing” of a policy related to the mobile unit 31, the IWM system 60 will send a message (or command) to the wireless agent 55 on the mobile unit 31. The command may be, for example, a command to shut down the device, to reconfigure the device, to change a mode of operation, etc. The wireless agent 55 may then communicate this information to the appropriate software on the mobile unit 31 to carry out the desired command (e.g. the operating system).

In contrast, when the mobile unit 31 is operating offline, the wireless agent 55 may continue to collect information, but this information is not sent to the IWM system 60 because the mobile unit 31 is not connected to the network 1. If the information were to be communicated to the IWM system 60, the information may have fired a policy so that the IWM system 60 would take a management action consistent with the specific policy. Thus, in the offline situation, there may be instances where the wireless agent 55 collects information that indicates a management action should be taken, but there is no communication of this information to the IWM system 60 for the management policy to be invoked.

This may be especially troublesome to the owner of the network 1 when the management action is associated with command and control management of the devices. Command and control management may be defined as those actions which are used to protect the integrity of the device, data and/or the network. These actions may be invoked by, for example, malicious or unauthorized use of the mobile device. The management actions may include, for example, locking down the device, encrypting or destroying data, stopping a task running on the device, etc.

The present invention is not limited to offline command and control management, but this may be the type of management which is most important in offline situations to prevent unauthorized use of the mobile devices. Other types of management may include, for example, configuration management, status management, performance management, etc.

Thus, in the exemplary embodiment of the present invention, the management policies which are implemented by the IWM system 60 for management of the mobile devices (e.g., mobile device 31) may be downloaded from the IWM system 60 to the wireless agent 55 so that these policies may fire when the mobile unit 31 is operating offline. These policies may be stored locally on the mobile unit 31. Thus, when the wireless agent 55 collects the information concerning the mobile unit 31, this information may be input into the locally stored management policies to determine whether a management action should be taken for the mobile unit 31. The wireless agent 55 may then instruct the appropriate software on the mobile unit 31 to take the management action without intervention of the IWM system 60.

It should be noted that throughout this description the wireless agent 55 is described as collecting information which may be used to determine if an offline policy should fire. The information collected by the wireless agent may include actual parameter values for different parameters (e.g., battery level is 50%) or it may include an event (e.g., low battery event). The difference being that for actual parameter values, these values need to be compared to some threshold to determine if a policy should fire. Whereas, with events, the policy may fire at the reception of the event. The exemplary embodiments of the present invention may be used with either type of information collected by the wireless agent 55 and nothing in this description should be regarded as limiting the present invention to one type of information.

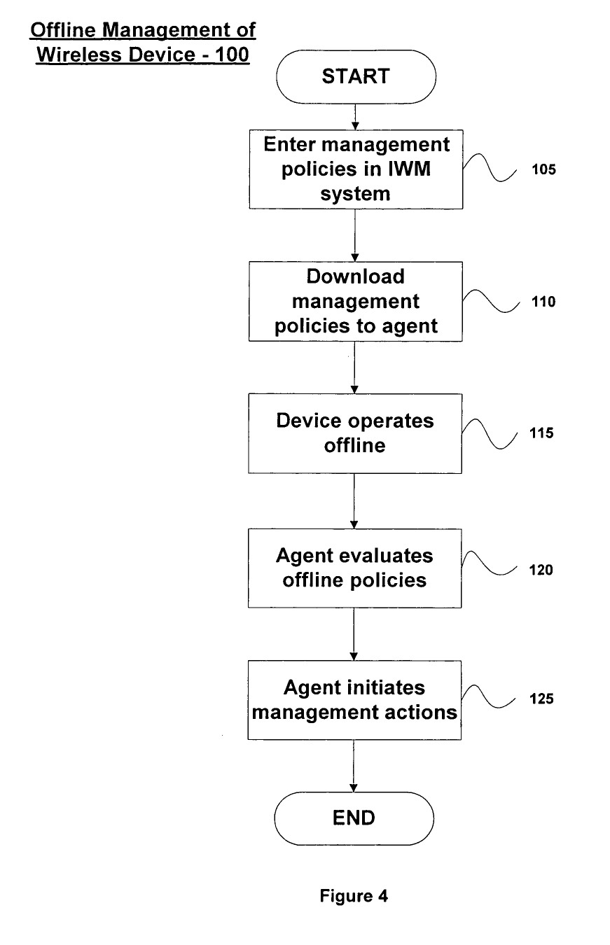

FIG. 4 shows an exemplary embodiment of a method 100 of offline management of a wireless device. The method 100 will be described with reference to the offline management of the mobile device 31. However, as described above, the method 100 may be implemented for the management of any network device capable of operating offline. In step 105, a system administrator enters the management policies for the network 1 into the IWM system 60. As described above, the IWM system 60 may be an enterprise management system which manages and controls all of (or various portions of) the network 1. Thus, the IWM system 60 may have hundreds or thousands of management policies depending on various characteristics of the network 1, e.g., number of attached devices, network usage, network security, etc. One of the purposes of having the IWM system 60 is to maintain central control over the network 1 without having to implement individualized control at each of the devices, thereby more efficiently managing the network 1.

Therefore, there may be a multitude of online management policies which are implemented for the management of mobile device 31. The system administrator (as part of step 105) may determine which of these online management policies should also be active when the mobile device 31 is operating offline. This determination may include all of the online management policies or a subset of the online management policies. In addition, the system administrator may define new policies which are only applicable when the device is operating offline. Examples of offline management policies (e.g., online management polices applicable for offline use and/or policies exclusive to offline use) will be provided below.

Different types of devices may receive different types of offline management policies. For example, mobile devices may receive different offline management policies than a desktop computer that may be connected wirelessly to the same network. Also, the same types of devices may receive different types of offline management policies based on some characteristic of the device (e.g., type of usage, area of use, etc.) For example, a mobile device that is operating in a warehouse for inventory control may have different offline management policies than a mobile device which is used in a retail location for conducting transactions, even though they are connected to the same network.

Typically, though not required, it should be expected that the offline management policies will be a subset of the online management policies implemented by the IWM system 60 because of the limited capabilities of the mobile device 31. A typical mobile device will have less processing power and memory than the network appliance 10 on which the IWM system 60 is implemented and the main purpose of this processing power and memory of the mobile device is to accomplish the tasks assigned to the mobile device (e.g. managing inventory). Thus, overloading the mobile device 31 with management policies may be undesirable. As described above, one manner of limiting the number of management policies that are downloaded for offline use may be by defining those command and control policies which protect the integrity of the mobile device and/or the network 1.

After the system administrator has defined the offline management policies for the mobile device 31 in step 105, these policies may then be downloaded to the wireless agent 55 to be stored locally on the mobile device 31 (step 110). The downloading may occur via a message exchange between the IWM system 60 and the wireless agent 55. The downloading may be manual, e.g., the system administrator may indicate that a download of policies occur, or automatic, e.g., the policies may be downloaded (or updated) at regular intervals based on time (daily, weekly, etc.) or actions (a change was made to a policy at the IWM system 60, a certain operating parameter was detected triggering a download).

In addition, it may be possible to have specific downloads set for intended actions. For example, the mobile device 31 may have a core set of offline management policies which are downloaded (or updated) on a regular basis (e.g., weekly). However, the IWM system 60 may also maintain a secondary set of offline management policies that are defined for specific event that are downloaded based on the occurrence of that event, the request of a user or under the direction of the system administrator. An example of an event may be that the mobile unit 31 is used at a different location one day out of every week and when at this different location, the secondary set of offline policies should be used. Thus, the system administrator may set a rule that indicates that the secondary set of offline management policies should be downloaded on a particular day. Similarly, the user may send a message indicating that the secondary offline management policies should be downloaded to the mobile unit. In a final example, the mobile unit 31 may detect (on its own or through the network 1) its location and based on this location information which is forwarded to the IWM system 60, the secondary offline management policies may be downloaded to the mobile unit 31. Thus, the preceding examples illustrate that there may be any number of triggers for downloading or updating offline management policies on the devices.

In an alternative embodiment, it may also be possible to download multiple sets of offline policies to the mobile unit 31. A specific set of offline policies may then be activated as required based on a command from the IWM system 60 or an internal command on the mobile device 31. This embodiment avoids the need to download new policies when a change is made.

In step 115, the mobile device 31 begins to operate in an offline mode. This switch to the offline mode is communicated to the wireless agent 55. In step 120, the wireless agent 55 will collect the information in the normal manner as described above. While not essential to the exemplary embodiment of the present invention, the wireless agent will store the collected information and forward the information to the IWM system 60 when the mobile unit 31 is next connected to the network 1, i.e., online. However, in the offline mode, the wireless agent 55 will include a policy engine allowing it to evaluate the locally stored offline management policies against the collected information.

If any of the offline management policies are fired by the collected information, the wireless agent 55 will invoke the appropriate management action in step 125. Those of skill in the art will understand that the offline management policies will include both the triggering mechanism for the policy (e.g., the collected parameter and value for the collected parameter for which the policy should be fired) and the management action which should be taken when the policy is fired (e.g., locking down the device). When an offline management policy is triggered, the wireless agent will communicate the corresponding management action to the appropriate software component on the mobile device 31 in order to initiate the management action.

Those of skill in the art will understand that steps 120 and 125 may be performed continuously while the mobile unit 31 is in the offline mode. Thus, steps 120 and 125 will be performed until the mobile device 31 is re-connected to the network. The frequency of the evaluation of the offline management policies may depend on any number of factors. For example, a policy may be evaluated each time the wireless agent collects a value for a parameter that is used for determining if the policy should fire. In another example, each policy may have a set time for when the policy should be evaluated. In a final example, the wireless agent 55 may be set with a predetermined time to evaluate offline management policies (e.g., every 5 seconds, etc .). Thus, any number of factors may determine when the wireless agent 55 evaluates the offline management policies when the mobile device 31 is operating in the offline mode.

As described above, the exemplary embodiment is described with reference to a wireless agent 55 being resident on the mobile device 31. However, it is possible to implement all the functionality described above for the management agent 55 in one or more software components that are loaded onto the mobile device 31 without having a software component that is labeled as an agent on the mobile unit.

The following describes several exemplary management policies that may be implemented as offline management polices as described above. The only limit to the actual policies that may be implemented on a particular device is the capabilities of the device (e.g., processing capability, memory space, etc.). Thus, the following policies are only presented as a limited number of examples.

Initially, examples of triggering actions or events for offline management policies will be presented. Exemplary management actions based on these triggering events will be provided below. In a first example, the triggering event of an exemplary offline management policy may be based on the simple determination of whether the device is connected to the network, i.e., the triggering action is the device going into the offline mode. As described above, when the mobile device 31 goes into the offline mode, this information may be communicated to the wireless agent 55 that may use this as a trigger to start evaluating the locally stored offline management policies. In addition, one or more of the offline management policies may have a trigger (or firing parameter) of whether the mobile device 31 is offline. When comparing the parameter (i.e., online or offline) to this type of offline management policy, the fact that the device is operating offline will cause the management policy to fire and the corresponding management action to be invoked.

In another example, the triggering parameter may be a period of inaction of the device when it is offline (e.g., there has been no user interaction with the device for 5 minutes). A further example may have a triggering parameter of the running of unauthorized applications. For example, the operating system of the mobile device 31 may have a Solitaire game which is not authorized for use on the mobile device. If this application is detected as running, a management action may be invoked to, for example, shut down the application.

In a final example of triggering parameter(s), the wireless agent may receive information concerning anomalous usage patterns such as the running of different applications, the collecting of data, etc. This may be a triggering event for an offline management policy. This example also shows that an offline management policy may be triggered by more than one collected parameter.

In the previous examples and throughout this description the terms triggering or firing were used in combination with the terms event and/or parameter. These terms are used interchangeably and are meant to indicate that a condition of the offline management policy has been satisfied.

In each of the above examples, the triggering event may have invoked an action that is to be taken on the device in response to triggering the offline management policy. This action is referred to as a management action. In each of the above examples of triggering events, the management action may be the locking down of the device so that it may no longer be used. As described above, in the offline mode, the IWM system 60 has no direct control over the device. Thus, it may be important to prevent attacks on the integrity of the device (or the network when the device is re-connected to the network). This may be done by setting offline management policies which lock a user out of the device if the management policy is fired.

Other examples of management actions may include, for example, requesting the user to re-authenticate for continued use of the device, encrypting data or destroying data on the device, queuing an event to go to the IWM system when the device is re-connected to the network, starting or stopping a selected process on the device, displaying a message on the device user interface indicating a problem or other alert to the user, sounding an audible alarm on the device, powering off the device, etc.

In another example, the offline management policy may include a connection profile for the device. The connection profile may define the conditions that are required for the device to re-connect to the network after it has moved offline. Thus, the trigger for the policy may be an indication that the device moved into an offline mode. The action may be to ensure that certain parameters are met prior to allowing the device to re-connect to the network.

In another exemplary embodiment, when an offline management policy fires, an indication of this firing will be sent to the IWM system 60. For example, when any offline policy fires, it may cause an event to be queued so that when the device is reconnected to the network 1, the IWM system receives a notification of the offline policy firing, the information which caused the policy to fire an the specific management action taken in response to the policy firing. This allows the IWM system 60 to maintain a log of policies (both online and offline) that were fired and may also prevent an online policy from firing based on the information which already triggered the offline policy.

Those of skill in the art will understand that there may be many other triggering events and/or management actions. A skilled system administrator (or others) may define the triggering events and the appropriate management actions in response to these triggering events that are necessary to protect the devices and/or network on which the offline management policies are used.

Throughout the above description, the term offline management policy was used to describe policies that may be implemented on the device when it is offline from the network it should be understood that the policy is not limited to network management, but may be related to any aspect of mobility enterprise management for the device, e.g., data integrity/security, power management, memory and processor usage, subsystem availability, network connectivity, etc.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
receiving an offline management policy from an enterprise management system of a network, the offline management policy including a triggering parameter and a management action;
storing the offline management policy;
comparing, when a device is offline from the network, a collected parameter to the triggering parameter; and
initiating the management action when the collected parameter satisfies the triggering parameter.

2. The method of claim 1, wherein the collected parameter is an actual parameter value.

3. The method of claim 1, wherein the collected parameter is an event.

4. The method of claim 1, further comprising:
receiving the collected parameter.

5. The method of claim 1, further comprising:
receiving an indication that the device is offline.

6. The method of claim 1, wherein the triggering parameter is one of an indication the device is offline, a time of non-use of the device and an indication of a running of an unauthorized application.

7. The method of claim 1, wherein the management action is one of requesting a user to re-authenticate, locking down of the device, encrypting data on the device, destroying data on the device, queuing an event to be sent to the enterprise management system when the device is reconnected to a network, starting an application, stopping the application, displaying a message to the user, sounding an audible alert on the device and powering off the device.

8. The method of claim 1, further comprising:
receiving an update of the offline management policy; and
storing the update.

9. The method of claim 1, wherein the offline management policy is a plurality of offline management policies.

10. The method of claim 1, wherein the comparing step occurs based on one of an elapsed time from the device going offline, an elapsed time indicated in the offline management policy and a frequency of an update of the collected parameter.

11. A device, comprising:
a protocol application for wirelessly connecting to a network;
a plurality of software applications; and
a wireless agent to receive an offline management policy from an enterprise management system of the network, the offline management policy including a triggering parameter and a management action, compare, when the device is in an offline mode, a collected parameter to the triggering parameter and initiate the management action when the collected parameter satisfies the triggering parameter.

12. The device of claim 11, wherein the collected parameter is one of an actual parameter value and an event.

13. The device of claim 11, wherein the device is a mobile device.

14. The device of claim 11, further comprising:
a memory to store the offline management policy.

15. The device of claim 11, wherein the wireless agent initiates the management action by communicating with at least one of the software applications.

16. The device of claim 11, wherein the triggering parameter is one of an indication the device is offline, a time of non-use of the device and an indication of a running of an unauthorized application.

17. The device of claim 11, wherein the management action is one of requesting a user to re-authenticate, locking down of the device, encrypting data on the device, destroying data on the device, queuing an event to be sent to the enterprise management system when the device is reconnected to a network, starting an application, stopping the application, displaying a message to the user, sounding an audible alert on the device and powering off the device.

18. The device of claim 11, wherein the wireless agent collects the collected parameter from at least one of the software applications.

19. The device of claim 11, wherein the offline management policy is a plurality of offline management policies.

20. The device of claim 19, wherein one of the offline management policies is activated based on a command received by the wireless agent, the command being in response to an activity of the device.

21. A system, comprising:
an enterprise management system residing on a network device for managing a wireless network, the enterprise management system including an offline management policy;
a wireless agent residing on a second network device, the enterprise management system sending the offline management policy to the wireless agent when the second network device is connected to the network, wherein the wireless agent manages the second network device using the offline management policy when the second network device is not connected to the wireless network.

22. The system of claim 21, wherein the offline management policy includes a triggering parameter and a management action and the wireless agent compares a collected parameter to the trigger parameter.

23. The system of claim 22, wherein the wireless agent initiates the management action when the collected parameter satisfies the trigger parameter.

24. The system of claim 21, wherein the network device is one of a network appliance and a network server.

25. The system of claim 21, wherein the second network device is a mobile device.

26. The system of claim 21, wherein the enterprise management system send the offline management policy to the wireless agent via one of an access point and a wireless switch.

27. The system of claim 21, wherein the offline management policy corresponds to an online management policy stored in the enterprise management system.

28. The system of claim 21, wherein the wireless agent sends a message to the enterprise management system indicating that the offline management policy was triggered, the message being sent when the second network device reconnects to the network.
